(19) United States
(12) Patent Application Publication
(10) Pub. No.: US 2026/0088986 A1
(43) Pub. Date: Mar. 26, 2026

(54) METHOD FOR SIGNING OR DECRYPTING DATA WITH A CRYPTOGRAPHIC KEY AS WELL AS COMPUTER PROGRAM PRODUCT AND DEVICE THEREFOR

(71) Applicant: TrustNXT GmbH, Hamburg (DE)

(72) Inventor: Timm von der Mehden, Ahrensburg (DE)

(21) Appl. No.: 18/894,278

(22) Filed: Sep. 24, 2024

(51) Int. Cl. H04L 9/08; G06F 21/60; H04L 9/30

(52) U.S. Cl. CPC H04L 9/0863; G06F 21/602; H04L 9/0825; H04L 9/3073

(57) ABSTRACT

A method for signing and/or decrypting data with a cryptographic key comprises a receiving of a request for generating at least one key for signing or for decrypting data, a detecting of an indicator, a selecting of at least one physical property of at least one component of a device as a function of the indicator, a generating of at least one key as a function of the selected physical property, and a signing and/or decrypting of the data as a function of the at least one key. The disclosure further relates to a computer program product and a device.

### BACKGROUND

### Technical Field

The present disclosure relates to a signing and/or decrypting of data with a cryptographic key. The present disclosure moreover relates to a device for signing and/or decrypting data with a cryptographic key as well as a computer program product for carrying out the method on the device.

### Description of the Related Art

It is well known from the prior art to connect data to a signature, namely a digital signature. With the signature, namely an electronic or digital signature, a signer or signature creator can be identified clearly and the integrity of the signed data can be checked. For signing purposes, a signature is created by a sender or signer with the help of a private key for the data to be signed, for example in the case of asymmetric cryptographic methods. The signature is added to the data. A recipient of the data and of the signature can check with the help of a previously received public key of the sender whether the signature and that data clearly originate from the sender.

Instead of or in addition to adding the signature, data can also be encrypted and decrypted again by means of keys, in particular cryptographic keys. For encrypting purposes, the encryption of data can take place with a public key of a recipient, which data the recipient can then decrypt with his private key, by means of the already mentioned asymmetric cryptographic method, which is also referred to a asymmetric decryption method.

Devices, which are configured for signing or decrypting, carry a key, in particular a private key, for signing or decrypting usually in a memory, which is often protected especially against being read by unauthorized persons. It is ensured hereby that a key, in particular the private key, cannot be used by unauthorized persons in order to sign or to decrypted data. To protect a memory against being read by a third party, however, is highly complex and a complete protection of the key is difficult to implement. It is desirable for this reason to forego the storing of secret keys as completely as possible.

A method, by means of which the storing of secret keys can be forgone, is based on the use of so-called “physical unclonable functions,” namely physically non-copyable functions, which are also referred to as PUF in short. PUF of this type are hardware structures in a semiconductor, which serve the purpose of providing a clear identification of the semiconductor and to secure keys therefrom for cryptographic methods. According to this, a PUF represents a unique individual feature, which is tied to a physical object, for example a device for signing or decrypting.

In detail, physical properties of a component, such as, for instance, of a semiconductor, are used to generate a secret key only if the latter is required. For example, a charge decay curve of a capacitor is recorded and start values for generating a complex key are extracted from the temporal course of the charge decay. Alternatively, the charge decay curve, converted into digital information, such as a bit sequence, can also be used itself as key. The use of “physical unclonable functions” thus makes it possible to forego the storing of the key because the latter can be deleted again directly and can be newly generated at any time after being used for signing or decrypting.

It is important to note hereby that states or courses of physical properties of hardware structures usually change in the course of time. Used physical properties, such as switch-on state of a sensor for generating a key, can thus be changed by aging the sensor or by cosmic radiation. After a certain period of time has elapsed, a device, which uses a pre-selected hardware structure or a component for generating a key, generates keys, which deviate from the keys originally generated with the same hardware structure or the same component. If such a deviation occurs, a private key generated from the hardware structure thus changes in the example of an asymmetric cryptography method. Data, which is to be decrypted or to be signed with a private key and which was encrypted with a previously valid public key or the integrity of which is to be checked with a previously valid public key, can no longer be decrypted with the changed private key or be signed in order to determine the integrity. It is thus necessary to distribute a public key, which therefore corresponds to the new private key.

Such a new distribution of keys is unpracticable and data already encrypted with old public keys can no longer be decrypted because an old private key cannot be reconstructed.

Moreover, the change of a physical property may not occur deterministically in a transitional time period. The change between an old and a new key is difficult to predict and a switch from the new key back to the old key may even occur in the transitional period.

The same physical property of the component can thus temporarily lead to the generation of an original key and temporarily to the generation of a changed key during a transitional period, in which a physical property of a component changes from an original or previous state into a changed state as a function of external influences, such as, for example, the temperature. A clear decryption or checking of the signature, respectively, is then no longer possible. For a user, a use of the hardware structure for generating the key is thus impracticable or even impossible in particular during the transitional time of the physical property of the hardware structure.

### BRIEF SUMMARY AND INITIAL DESCRIPTION

The present disclosure addresses problems of the prior art. In particular, a possibility is to be found for signing or for decrypting data with a key generated from a PUF, wherein a transitional state of the PUF, thus a changing physical property of a component, is to be taken into account. In any event, an alternative for that, which is known from the prior art, is to be found.

For this purpose, the present disclosure relates to a method for signing and/or decrypting data with a cryptographic key according to claim 1.

The present disclosure thus relates to a method for signing and/or decrypting data with a cryptographic key. A cryptographic key corresponds, for example, to a bit sequence, preferably with predefined length.

According to the present disclosure, the method initially comprises the receiving of a request for generating at least one cryptographic key for signing or decrypting data. A request can be, for example, a request within a device, which is generated automatically. For instance, the start of an application, with which data is to be decrypted, is one example for a request of this type. A general start, thus a powering or booting, of a device, with which data can be signed or decrypted, can be a further request. However, a request can also be received by a user interface. The reception of a request can thus be considered as activator or trigger for starting a signing or decrypting process.

An indicator is detected in the next step. The indicator comprises, for example, data, which is read from a memory location and which is generated in the device or data, which is likewise received by a user interface. A physical property is then selected as a function of the indicator.

A physical property is hereby connected to at least one component of a device. A physical property of at least one component is thus selected. The physical property describes, for example, a measurable physical behavior of the component or of several components, which jointly have this physical property, preferably during predefined circumstances.

A physical property of at least one component comprises, for example, a temporal discharge curve of a capacitor. The predefined circumstances can correspond, for example, to a predefined charge state of the capacitor, starting at which the charge curve is measured. A physical property can further comprise any other temporal behavior of a component. In the case of several first components, for example different resistors, the physical property can correspond to the resistance values of each of the resistors or also to a mathematical connection of the resistance values. A physical property of at least one component preferably corresponds to a “physical unclonable function.”

It is a special feature that the physical property is selected as a function of the indicator. Several physical properties are thus predefined, wherein one or several physical properties of the predefined physical properties are selected as a function of the indicator for the further method.

In a further step, at least one key is then generated as a function of the at least one physical property and data is then signed and/or decrypted as a function of the at least one key.

By way of a selection of the physical property as a function of the indicator, the possibility is created to provide several different physical properties for generating a key and to select them as a function of the indicator. For example, a different physical property can be selected hereby by simply changing the indicator, for example as soon as it has been determined that a physical property, namely preferably a PUF, has changed and a key generated therefrom thus deviates from the previously generated key.

For example, a reference file can be provided in the device and can be signed with the generated key after receiving a request for generating the key. It can then be checked by way of a previously stored public key whether the signature is valid. If the signature is invalid, it is indicated thereby that the key for signing no longer corresponds to the previously generated key. The indicator can then be changed, for example, in order to select a different physical property and to avoid a non-deterministic behavior during the key generation.

According to a first embodiment, a set with several, in particular more than two or exactly two physical properties of one or several components, is selected as a function of the indicator. The set thus preferably corresponds to one of several predefined sets. Each of the sets comprises several physical properties, which are likewise preferably predefined for the respective set.

Several physical properties are thus selected, which are each assigned to at least one component. The components, which are assigned to one physical property, are preferably not assigned to a different physical property. At least one key is further generated as a function of each of the selected physical properties in each case. The data is additionally signed and/or decrypted with each of the generated keys.

According to the last-mentioned embodiment, for example, a set is selected as a function of the indicator, which, due to its physical properties, which each correspond to a discharge curve of a component, in each case generates a key as a function of the two discharge curves. The file is then signed and/or decrypted with both keys. If one of the keys fails or is invalid because one of the underlying physical properties has changed, the physical property of the other component is stable with sufficient probability. The second key thus still remains valid and a signature can then be checked therefore with a corresponding public key.

A decrypting with at least one of the generated keys is therefore successful. A recipient of the data can thus still check the signature with a different key or can decrypt the data even in the event of the failure of a key. The probability of a complete failure therefore increases with the number of the selected physical properties in a set.

When an invalid key or a key which fails is mentioned here and in the following, this refers to a key, which is generated from a physical property of a component, but which differs from a key, which has previously been generated with the physical property of the component, by changing the state of the physical property.

Even in the case of failure or in the case of invalidity of a key, thus a changed physical property of a component, data can thus be encrypted and decrypted or signed, respectively, at any time.

According to a special embodiment of the above-described embodiment, at least two physical properties are thus selected in step c). A first physical property of the two physical properties corresponds to a physical property of at least one first component. A second physical property of the two physical properties corresponds to a physical property of at least one second component, which differs from the first component.

According to a further embodiment, at least three physical properties are selected in step c). A first physical property of the three physical properties corresponds to a physical property of at least one first component and of a second component. A second physical property of the three physical properties corresponds to a physical property of at least the second and of a third component. A third physical property of the three physical properties corresponds to a physical property of at least the third and of the first component.

Each of three keys is thus based on the physical property of at least two components.

A change of a behavior of a component thus leads to the failure of two keys. This is accepted, however, in order to provide for a comparatively higher bit depth of the keys, thus the number of the bits of each of the keys, with comparatively few components. A device, which provides only a small number of components for generating keys, for example, can thus be used to generate the longest possible keys. By using three physical properties and thus three keys, however, the failure of a component, thus a change of the physical properties, still has at least no effects on at least one of the keys. This one of the three keys still remains valid.

According to a further embodiment, the indicator indicates one set to be selected of several sets. The sets are preferably predefined. Each set in each case comprises several physical properties. The physical properties of each set are preferably likewise predefined. At least one physical property of each selectable set differs from a physical property of a different set. If, for example, a first set thus comprises the physical properties A, B and C, then a different set comprises the physical properties B, C and D. A further set, in turn, comprises the physical properties C, D and E.

It can thus be ensured that in the event of a failure of a key, thus of a key which becomes invalid, which can be assigned to a set via a physical property, a previous set can be replaced by selecting a different set, which does not contain the physical property for generating the failed key. By adapting the indicator, a complete set with assigned valid keys can thus be obtained again.

With the selection of a new set, the group of physical properties is thus supplemented by previously not yet used physical properties. No identical sets exist.

According to a further embodiment, the sets of physical properties have an order. One or several sets following a previous set in that order each comprise at least one physical property, which is identical to the previous set. An identical physical property thus leads to the generation of an identical key, as long as a state of the physical property does not change. For example, a first set of the sets thus comprises the physical property A and the physical property B, as second set following in that order comprises the physical property B and the physical property C. A further second set following the first set comprises, for example, the physical property A and the physical property C. A third set following this in that order comprises the physical property C and the physical property D.

By specifying the order, it is possible that a new set following in that order can be selected with the indicator, in that all keys can be considered to be valid again. A backwards compatibility to data, which would need to be decrypted with a key that has become invalid, is additionally made possible because the following set comprises at least also a physical property, with which a key, which was already valid previously, is generated. The new set thus generates at least one key, in order to decrypt data, which has to be decrypted with the keys of a precious key. If, for example, key A from the mentioned first set becomes invalid, a change-over can be made to the second set. The keys B and C according to this example are contained in set two. If key B were to fail in the first set, a change-over to the further second set would be made, in which the keys A and C are contained.

According to a further embodiment, a state or a time indication is monitored and detected. A time indication comprises, for example, a point in time, in particular a date or a time period. A state can be the monitoring of the physical properties of a currently valid set. A state can also correspond to a decay of atoms or a gas discharge. To monitor a state can correspond, for example, to a measurement of a Geiger counter integrated in the device, which monitors the decay of atoms, which are to be considered, of a component, the physical property of which is monitored. Cosmic radiation can likewise be measured, thus monitored, with the Geiger counter.

According to this use case, a previous value of the indicator is actually maintained in the event that a stored or storable criterion, which is comparable to the time indication or the state, remains unmet. The indicator thus remains constant during each run-through of the method. The same set of physical properties is executed when repeating the steps according to the present disclosure after a reception of a request for generating at least one key all the way to the signing or decrypting of the file.

This means that an identical set or the identical physical properties is always selected. According to this embodiment, this takes place until the criterion is met. This is so because in the event that the criterion is met, the indicator, thus preferably its value, is changed. A set, which differs from the previously selected set, is thus selected. A set is preferably selected, which, in an order of the sets, corresponds to a set following the previously selected set.

A criterion can be an expiry point in time, such as an expiry date, a reaching of a time period, the recognition of the device of a changing physical property or a recognition that the device was exposed to a certain quantity of cosmic radiation.

An automatic changing of the sets as a function of the indicator thus takes place as a function of the time or a state and a criterion.

A state can also be the checking of the signature, which, as already mentioned above, is carried out with the signed reference file and the public stored key. The criterion is then the validity or invalidity of the signature.

A comparison of the state or of the time indication with a criterion thus describes the independent recognition of the device that the necessity of the generation of a new key exists. This recognition can be achieved by detecting changed hardware structures, thus of the physical properties, with the device, for example by measured values and the reaching of tolerance limits.

According to the embodiment, a renewal of the keys is thus possible in an event-or time-dependent automated manner, without a user of a device having to take care to renew the keys in due time.

According to a further embodiment, several criteria are stored and after meeting one of the criteria by the state or the time indication in each case, a set is selected with the indicator, which differs from the one or all sets, which were selected prior to meeting the respective criterion. The indicator is thus preferably changed to a value, which it has not assumed yet. Differing sets correspond to sets with at least one different physical property.

A continuous renewal of the keys by excluding already used sets can take place in this way.

According to a special embodiment, a control instance is provided, which recognizes a change of a physical property. This can take place, for instance, when a separate public key of the device, which is stored, for instance, in the device, changes. This applies for the case that the separate public key is generated as a function of a separate private key, which, in turn, is generated as a function of the physical property. A comparison of a stored and of a newly generated public key then shows the change of the physical property. The control instance can then preferably adapt the indicator or can check whether a changed physical property is so table that it can still be used to generate a key, without changing the indicator.

According to a further embodiment, the control instance issues at least one new public key after a change of a physical property is recognized, which key is generated as a function either of the changed physical property with the same indicator or of a different physical property, selected by a changed indicator.

According to a further embodiment, the indicator and/or the criterion changes in response to each run-through of the steps according to the present disclosure from the receipt of a request for generating at least one key all the way to the signing and/or decrypting of the data as a function of the at least one key. In particular, in the event that sets have an order and that an identical physical property and a changed physical property is in each case contained in consecutive sets, an order of the encrypted or signed data can thus be identified.

If, for example, a first set contains the physical properties A and B, a second set contains the physical properties B and C, a third set contains the physical properties C and D, the files with the first set, thus with keys from the physical properties A and B, are signed when the method is carried out for the first time. Upon the subsequent run-through, data with the second set, thus with the keys generated from the physical properties B and C, are signed. This continues so that a recipient of the data of a run-through can only decrypt this data if he is also recipient of the data of the previous run-through.

According to a further embodiment, the indicator corresponds to a command or an order, which is preferably received by a user interface. The at least one physical property is thus selected as a function of the command or order. In particular, a set of physical properties, which is a function of the command or order, is selected. A set of physical properties, which corresponds to one of several predefined sets of physical properties, is preferably selected with the command or the order.

According to this, a user of an internal monitoring control of the device, which monitors, for example, the state of the physical properties or also a different application, can select a set of predefined physical properties with the help of a command or an order. The sets are preferably predefined and are provided for the selection. It is possible hereby that a user does not have to select physical properties in his own. In the case of a key, which is no longer valid, the user or an application can, by specifying a command or an order with which a different set can be selected, select the other set, which makes it possible to generate keys, which are valid for a new time period.

According to a further embodiment, the indicator comprises a password or is selected as a function of a password. The password is, for example, a character string or corresponds to biometric data. A password of biometric data is also referred to as biometric password and can corresponds to a fingerprint or the like. As a function of the password, one of several sets is selected, which in particular correspond to predefined sets. The several sets preferably each comprise several physical properties, with which an electronic key can be generated in each case.

Alternatively, at least one physical property can be predefined and can be selected after the predefining as a function of the password. The password itself thus serves the purpose of specifying the indicator so that the latter obtains information as to which physical property is to be used for generating one or several keys. According to a further alternative, at least one of several predefined physical properties is selected as a function of the password.

Several passwords can thus be specified, which themselves do not serve the purpose of generating the electronic key. On the contrary, the passwords are in each case assigned to one of several sets of physical properties or directly to physical properties. By inputting a password, for example by a user, the latter selects, protected by the password, a physical property connected to this password with the help of the indicator, in order to generate the electronic key therefrom.

The key generation thus becomes even more secure.

According to a further embodiment, the at least one key, which is generated as a function of the at least one physical property, comprises one or several key pairs of an asymmetric encryption process. According to this, the data is signed as a function of the asymmetrical key pair in such a way that a hash of the file to be signed is formed initially and this hash is signed with each of the private keys of the generated key pairs. The results of the signing, namely the signature and preferably also the respective public key of the key pairs, are displayed in metadata of the data.

Alternatively, only the result of the signing, thus the encrypted or signed hash, can be displayed, wherein the public keys are transmitted separately.

A simple signing of data and transmission of the signed data with the help of an individual file, which has metadata, is thus possible. The method thus preferably serves the purpose of signing media, such as images, for instance.

According to a further embodiment, at least one of the public keys of a key pair is signed prior to the storing in the metadata of the data, in particular of a media file, such as of an image, beforehand with at least one private key of a further key pair. The private key of the further key pair is preferably a private key of a key, which can be generated identically from a current set and from a set, which differs from the current set. The set, which differs from the current set, is preferably a previous set in that order.

When a new public key is thus generated by a or as a function of a new set of physical properties, this new public key is signed beforehand with the previous private key. It can thus be prevented or least counteracted that such public keys, which do not originate from the actual user who signs the file, are introduced into the metadata.

According to a further embodiment, a plurality of physical properties is selected as a function of the indicator, wherein a plurality comprises, for example, at least 10 or at least 20 or at least 50 physical properties. A plurality of keys is therefore generated from the physical properties.

The state then represents the percentage or the number of the valid and invalid keys. A criterion is further met when a predefined percentage of the plurality of keys is recognized as being invalid. Otherwise, the criterion remains unmet. A new indicator, with which a new plurality of physical properties is selected, is then provided after the criterion is met. The predefined percentage corresponds, for example, to a percentage of 5%, 10% or 20%.

Data is thus signed or decrypted with the plurality of keys, which are generated from the plurality of physical properties, until a checking in the device recognizes that a predefined percentage of this plurality of keys becomes invalid. A new plurality of physical properties is selected by the indicator only after exceeding this predefined percentage, so that from that point on, data is signed or decoded with a plurality of new keys, which are considered to be valid.

The present disclosure further relates to a computer program product, which comprises instructions, which, when they are executed on a processor of a processing unit, prompt the processor to carry out the method according to one of the above-mentioned embodiments. A processing unit preferably a device or a part of a device, wherein the device corresponds, for example, to a computer, a tablet, a mobile telephone or the like.

The present disclosure additionally comprises a device for signing or decrypting data with a cryptographic key. The device is configured for carrying out a method according to one of the above-mentioned embodiments. The device is preferably a mobile device, such as a laptop or a mobile telephone or tablet. The device can further also correspond to any stationary computer.

The device preferably comprises a plurality of components, namely electronic components, such as, for example, hardware structures, which can be analog structures or digital structures. According to a special embodiment, the device itself can be an analog structure, which is configured for carrying out the method.

### BRIEF DESCRIPTION OF THE SEVERAL VIEWS OF THE DRAWINGS

Further embodiments follow on the basis of the exemplary embodiments, which are described in more detail in the figures, in which:

FIG. 1 shows a device according to an exemplary embodiment for carrying out a method,

FIG. 2 shows steps of an exemplary embodiment of the method,

FIG. 3 shows steps of a preferred exemplary embodiment of the method,

FIG. 4 shows a further exemplary embodiment of a selection step,

FIG. 5 shows a second exemplary embodiment of a step for detecting an indicator,

FIG. 6 shows a third exemplary embodiment of a step for detecting an indicator, and

FIG. 7 shows a fourth exemplary embodiment of a step for detecting an indicator.

### DETAILED DESCRIPTION

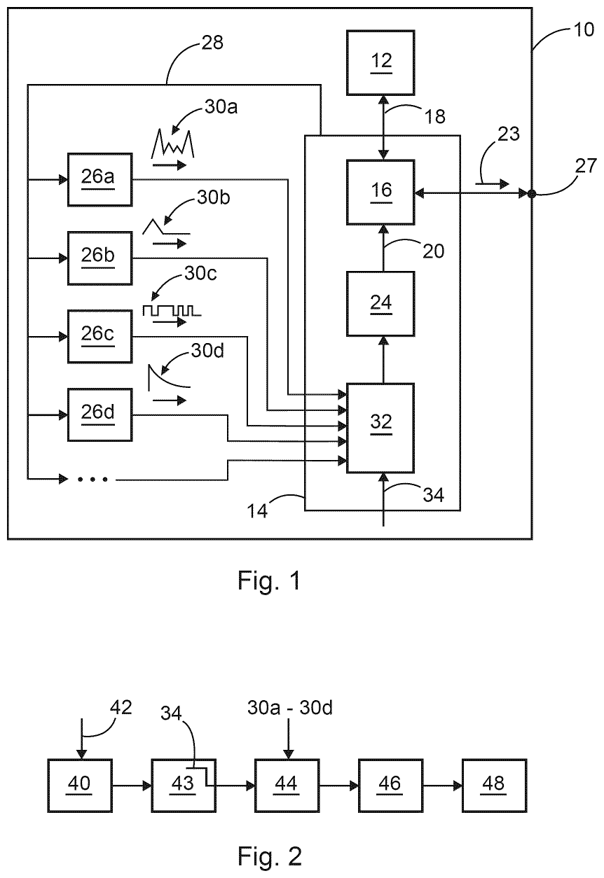

FIG. 1 shows a device 10 for signing and/or decrypting data with a cryptographic key. For this purpose, the device comprises a memory 12, in which, for example, data to be signed is stored. This data can correspond, for example, to media data, such as image data, for instance, which originates from an image sensor of a camera.

The device 10 further comprises a microcontroller unit 14, which comprises, for example, a processor and further modules required for the data processing. A crypto module 16 is provided in the microcontroller unit 14 in order to sign data 18, which is received from the memory 12, as a function of a key 20. After the signing, the data 18 can be output by the device 10 at an interface 22 with the signature 23. Encrypted data, which can be supplied to the crypto module 16, can also be received via the interface 22, in order to decrypt said data with the key 20.

The key 20 is determined with a key generator 24 as a function of a physical property of one or several components 26a, 26b, 26c, 26d of the device 10. According to this, the device 10 comprises the several components 26a, 26b, 26c, 26d. The components 26a, 26b, 26c, 26d correspond, for example, to sensors, further memory elements, digital hardware structures or circuits as well as analog electrical components.

For example, a trigger signal 28 can be sent with the microcontroller unit 14 to one or several of the components 26a, 26b, 26c, 26d, so that each of the components 26a, 26b, 26c, 26d or at least one or several selected components 26a, 26b, 26c, 26d send out a signal, which is in particular an analog signal. The signal indicates a physical property 30a, 30b, 30c, 30d of the respective component 26a, 26b, 26c, 26d. The key 20 can be determined as a function of the physical property 30a, 30b, 30c, 30d, which is supplied to the key generator 24.

A decision-maker 32 is further provided, which receives an indicator 34, with which one or several of the received physical properties 30a, 30b, 30c, 30d are selected and are supplied to the key generator 24 after the selection.

FIG. 2 shows steps according to an exemplary embodiment of the method, which can be carried out with the device 10 illustrated in FIG. 1. In a step 40, a request 42 for generating at least one key 20 for signing or for decrypting data 18 is received. In step 43, an indicator 34 is then detected. In step 44, at least one physical property 30a, 30b, 30c, 30d of at least one component 26a, 26b, 26c, 26d of the device 10 is further selected as a function of the indicator 34. In step 46, at least one key 20 is then generated as a function of the at least one selected physical property 30a, 30b, 30c, 30d and in step 48, the data 18 is signed as a function of the at least one key 20.

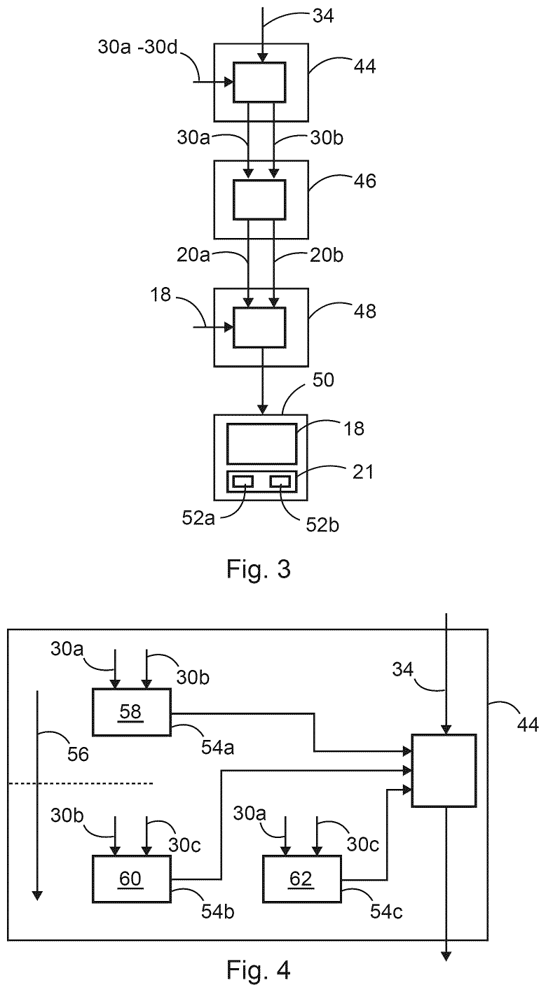

FIG. 3 shows a special exemplary embodiment of the steps 44, 46, 48 from FIG. 2. According to this exemplary embodiment, two physical properties 30a, 30b are selected as a function of the indicator 34 in step 44. In step 46, two keys 20a, 20b are generated as a function of the selected physical properties 30a, 30b, and the data 18 is signed with both keys 20a, 20b in step 48. According to this, a signed file 50, which has the data 18 itself and a first signature 52a as well as a second signature 52b in metadata 21, is thus output by step 48. The first signature 52a has been generated with the first key 20a and the second signature 52b has been generated with the second key 20b.

FIG. 4 shows a further exemplary embodiment of the selection step 44, in the case of which the physical properties 30a, 30b, 30c, 30d are assigned to several sets 54a, 54b, 54c. As a function of the indicator 34, one of the sets 54a, 54b, 54c is now selected and is output for the step 46. The step 46, which is not illustrated here, in each case generates a key 20a, 20b for decrypting or signing the data 18 as a function of the physical properties 30a, 30b, 30c, 30d of the selected set 54a, 54b, 54c.

The sets 54a, 54b, 54c are assigned, for example, to an order 56, wherein the set 54a corresponds to a previous set 58 in that order, the set 54b corresponds to a subsequent set 60 in that order and the set 54c corresponds to a further subsequent set 62 in that order. In this case, the indicator 34 can, for example, assume the values “1”, “2”, or “3”. In the case of an indicator 34, which assumes the value “1”, the previous set 58 is selected. In the case that the indicator assumes the value “2”, the subsequent set 60 is selected, and in the case that the indicator assumes the value “3”, the further subsequent set 62 is selected.

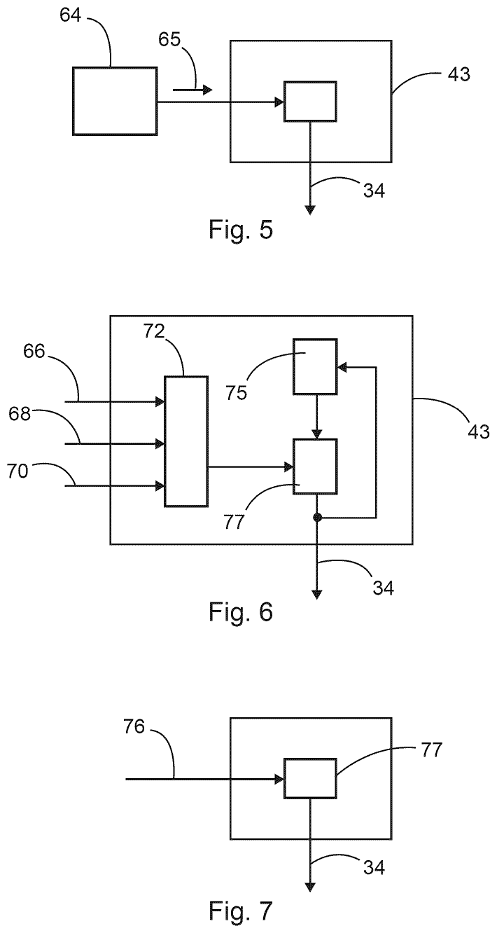

FIG. 5 shows an exemplary embodiment, in the case of which the indicator 34 is detected in step 43, in that a value, for example value “1”, “2”, or “3” is received as command 65 of the device 10 by a user interface 64.

An alternative detection of the indicator 34 according to a further exemplary embodiment is illustrated in FIG. 6. In a step 43 for detecting the indicator, a state 66 or a time indication 68 is compared here to a criterion 70 in a substep 72. The indicator 34 has a start value 74, which corresponds, for example, to the value “1” and which is read from a memory 75. This start value 74 is output as indicator 34 by a selection step 77 as long as the criterion 70 is recognized as not having been met in the substep 72. If the criterion 70 has been met, the indicator 34 is increased or adapted in the selection step and is output as new indicator 34. The new indicator 34 is stored as start value 74 again.

After the increase, the indicator 34 assumes the value “2”, e.g., so that the indicator 34 has the value “2” as value from that point on. After a change of an indicator 34, all indicators 34 which have already been selected previously, are preferably stored hereby, so that indicators 34, for example, cannot assume a value, which corresponds to a previous value, after a change in response to each run-through of the method. Indicators 34 already used prior to meeting criteria 70 are thus preferably not reused.

According to a further exemplary embodiment, FIG. 7 shows the selecting of one or several physical properties 30a, 30b, 30c, 30d as a function of an indicator 34, which is generated as a function of a password 76. In this alternative exemplary embodiment of step 43, the password 76 is supplied to a decoder 78, and an indicator 34, which corresponds to the result of the decoding, for selecting one or several corresponding sets 54a, 54b, 54c of physical properties 30a, 30b, 30c, 30d is selected as a function of the output of the decoder 78 in the selection step 77, in order to generate one or several keys 20a, 20b therefrom.

### LIST OF REFERENCE NUMERALS

10 device
12 memory
14 microcontroller unit
16 crypto module
18 data
20 key
20a first key
20b second key
21 metadata
22 interface
23 signature
24 key generator
26a component
26b component
26c component
26d component
28 trigger signal
30a physical property
30b physical property
30c physical property
30d physical property
32 decision-maker
34 indicator
40 receiving request
42 request
43 detecting indicator
44 selecting at least one physical property
46 generating key
48 signing data
50 signed data
52a first signature
52b second signature
54a set
54b set
54c set
56 order
58 previous set
60 subsequent set
62 further subsequent set
64 user interface
65 command
66 state
68 time indication
70 criterion
72 comparing event or time indication to criterion
74 start value
75 memory
76 password
77 selection step
78 decoder

The various embodiments described above can be combined to provide further embodiments. All of the U.S. patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method for signing and/or decrypting data with a cryptographic key, comprising steps of:
a) receiving a request for generating at least one key for signing or for decrypting data,
b) detecting an indicator,
c) selecting at least one physical property of at least one component of a device as a function of the indicator,
d) generating at least one key as a function of the selected physical property, and
e) signing and/or decrypting the data as a function of the at least one key.

2. The method according to claim 1, wherein, as a function of the indicator in step c), a set with at least two physical properties is selected,
wherein in step d), a key is generated as a function of each of the selected physical properties in each case, and in step e), the data is signed and/or decrypted with each of the generated keys.

3. The method according to claim 1, wherein in step c), at least three physical properties are selected, wherein a first physical property of the at least three physical properties corresponds to a physical property of at least one first component and of a second component, a second physical property of the at least three physical properties corresponds to a physical property of at least the second component and of a third component, and a third physical property of the at least three physical properties corresponds to a physical property of at least the third component and of the at least one first component.

4. The method according to claim 1, wherein the indicator indicates one set to be selected of several sets which each comprise several physical properties, wherein at least one physical property of each set differs from a physical property of any other set.

5. The method according to claim 4, wherein the sets of physical properties have an order and one or several sets following a previous set in that order each comprise at least one physical property which is identical to the previous set.

6. The method according to claim 1, wherein a state or a time indication comprising a point in time is monitored or detected,
wherein in the event that a stored or storable criterion which is comparable with the time indication or the state remains unmet, an indicator for detecting is specified, which remains constant and which is selected with the same set when repeating the steps a) to e), and
wherein in the event that the stored or storable criterion is met, an indicator for detecting is specified, which is changed compared to the constant indicator and with which a set which differs from the previously selected set is selected in step c).

7. The method according to claim 6, wherein several criteria are stored and after meeting one of the several criteria by the state or the time indication, a set is in each case selected, which differs from one of the sets or all sets which were selected prior to meeting the respective criterion.

8. The method according to claim 6, wherein the indicator and/or the criterion changes in response to each run-through of the steps a) to e).

9. The method according to claim 1, wherein the indicator comprises a command or an order in order to select in step c) at least one physical property which is a function of the command or order or a dependent set of physical properties.

10. The method according to claim 1, wherein the indicator comprises a password or is generated as a function of a password, and one of several sets is selected as a function of the password or at least one physical property is predefined and/or selected as a function of the password.

11. The method according to claim 1, wherein the at least one key comprises at least one key pair of an asymmetrical encrypting method and in step e), a hash of the data to be signed is signed with a private key of the at least one key pair or each of the private keys of generated key pairs, wherein the results of the signing and a respective public key of the key pairs are displayed as signatures in metadata of the data.

12. The method according to claim 11, wherein at least one or all of the public keys of a key pair in the metadata is additionally signed with at least one private key of a further key pair and is stored in the metadata after the signing, wherein the at least one private key of the further key pair is a private key of a key pair which can be generated identically from a current set and a set which differs from the current set.

13. The method according to claim 1, wherein in step c) a plurality of physical properties are selected and in step d) a plurality of keys are generated from the plurality of physical properties, wherein a state represents a monitoring of validity and invalidity of the plurality of keys, and wherein a criterion is met when a predefined percentage of the plurality of keys is recognized as being invalid and the criterion otherwise remains unmet.

14. A computer program product comprising a non-transitory computer-readable medium containing executable instructions, which, when executed by a processor of a processing unit, cause the processor to carry out the method according to claim 1.

15. A device for signing and/or encrypting data with a cryptographic key, wherein the device is configured for carrying out a method according to claim 1.
